(19) United States
(12) Patent Application Publication
(10) Pub. No.: US 2006/0250726 A1
(43) Pub. Date: Nov. 9, 2006

(54) Shield structure in magnetic recording heads

(75) Inventor: Jeffrey S. Lille, Sunnyvale, CA (US)

Correspondence Address: DUFT BORNSEN & FISHMAN, LLP, 1526 SPRUCE STREET, SUITE 302, BOULDER, CO, 80302, US

(73) Assignee: Hitachi Global Storage Technologies Netherlands B. V.

(21) Appl. No.: 11/125,391

(22) Filed: May 9, 2005

(51) Int. Cl. G11B 5/33; G11B 5/127

(52) U.S. Cl. 360/319

(57) ABSTRACT

Magnetic recording heads and corresponding methods of fabrication are disclosed. A recording head of the invention includes a read element with a first shield and a second shield on either side of the read element. The first shield and the second shield each include multiple shield layers connected upon one another to form a multi-level surface facing the read element. The surface of each shield is raised in relation to the read element. Therefore, the separation between the first and second shields is less proximate to the read element compared to the separation away from the read element. Because of the larger separation between the shields away from the read element, capacitive coupling between the two shields is advantageously reduced.

### BACKGROUND OF THE INVENTION

1. Field of the Invention

The invention is related to the field of magnetic disk drive systems, and in particular, to shield structures for a read element of a magnetic recording head.

2. Statement of the Problem

Many computer systems use magnetic disk drives for mass storage of information. Magnetic disk drives typically include one or more recording heads (sometimes referred to as sliders) that include read elements and write elements. A read element is sometimes referred to as a magnetoresistive (MR) element or an MR sensor. A suspension arm holds the recording head above a magnetic disk. When the magnetic disk rotates, an air flow generated by the rotation of the magnetic disk causes an air bearing surface (ABS) side of the recording head to ride a particular height above the magnetic disk. The height depends on the shape of the ABS. As the recording head rides on the air bearing, an actuator moves an actuator arm that is connected to the suspension arm to position the read element and the write element over selected tracks of the magnetic disk.

To read data from the magnetic disk, transitions on a track of the magnetic disk create magnetic fields. As the read element passes over the transitions, the magnetic fields of the transitions modulate the resistance of the read element. The change in resistance of the read element is detected by passing a sense current through the read element and then measuring the change in voltage across the read element. The resulting signal is used to recover the data encoded on the track of the magnetic disk.

A read element is comprised of a plurality of layers or thin films deposited to form a magnetoresistive (MR) stripe. The read element is sandwiched between a pair of magnetically conductive shields. The read element has an exposed edge at the ABS side of the recording head. The read element also has a back edge which is normally parallel to the air bearing surface and is embedded within the recording head.

Read elements may be current in plane (CIP) read elements or current perpendicular to the planes (CPP) read elements. First and second leads contact the read element for conducting a sense current through the read element. If the sense current is applied parallel to the major planes of the layers of the read element, then the read element is termed a CIP read element. If the sense current is applied perpendicular to the major planes of the layers of the read element, then the read element is termed a CPP read element. For CPP read elements, the shields sandwiching the read element often also function as the leads for the sense current.

FIG. 1 is a cross-sectional view of a recording head 100 in the prior art. In recording head 100, a read element 102 is sandwiched between two gap layers 104-105. The gap layers 104-105 are sandwiched between two shields 106-107. Shield 106 sits on an underlayer 110, which sits on a substrate 112. If read element 102 comprises a CPP read element, then there would be conductive material that connects the shields 106-107 to the read element 102, as the shields would also act as the sense current leads. If read element 102 comprises a CIP read element, then other leads (not shown) would conduct the sense current through the read element 102. Shields 106-107 are generally each a single layer of ferromagnetic material, such as a NiFe alloy. In this example, shields 106-107 are parallel to one another.

One edge of the layers of the recording head 100 is lapped to form the ABS. During a read operation, magnetized regions on a rotating magnetic disk adjacent to the ABS inject flux into the read element 102, causing resistance changes in the read element 102. Shields 106-107 absorb unwanted flux, such as fields from neighboring tracks on the magnetic disk, to improve the spatial resolution of the read element 102.

One problem with the structure of recording head 100, and in particular the structure of the shields 106-107, is that there is capacitive coupling between the shields 106-107. The shields 106-107 are relatively close together in order to shield the read element 102 from unwanted magnetic fields. The small separation between the opposing surfaces of shields 106-107 creates a capacitance that can add noise in recording head 100. If the shields 106-107 are separated to reduce the capacitive coupling, then they may not adequately shield the read element 102 from unwanted magnetic fields, especially for high-density magnetic disks.

In some recording heads, the shields are not parallel to one another. FIG. 2 is a cross-sectional view of a prior art recording head 200 that does not have parallel shields. As in FIG. 1, recording head 100 includes a read element 202 sandwiched between two gap layers 204-205. The gap layers 204-205 and insulation layers 211-212 are sandwiched between shields 206-207. Shield 206 sits on an underlayer 210. Shields 206-207 each comprise a single layer of ferromagnetic material having a curved shape.

To fabricate this curved shape, an insulation bump 220 is first formed by subtractively removing a portion of the underlayer 210. The process creates rounded corners on the bump 220. With the corners of the bump 220 rounded, the shield 206 may then be electro-plated on the bump 220.

Another process for making the insulation bump 220 may be through a lift-off process using a bi-layer resist process. This creates an undercut in the resist which allows for deposition and subsequent removal of the bi-layer mask material. This would leave behind a layer with a rounded edge.

One problem with the structure of the recording head 200 in FIG. 2 is the accuracy and difficulty of fabricating the recording head 200.

Another shield structure and corresponding method of fabrication is desired that is more efficient and more accurate.

### SUMMARY OF THE SOLUTION

The invention solves the above and other related problems with an improved shield structure in a magnetic recording head. In one embodiment of the invention, a recording head includes two shields on either side of a read element. The first shield and the second shield are both formed from two or more layers of ferromagnetic material. The first shield comprises a first shield layer and a second shield layer. The first shield layer has an outer surface and an inner surface relative to the read element. The second shield layer also has an outer surface and an inner surface relative to the read element. The outer surface of the second shield layer contacts the inner surface of the first shield layer to form the first shield, which is continuous. The size of the second shield layer is smaller than the size of the first shield layer, so the second shield layer only covers a portion of the inner surface of first shield layer. The positioning of the second shield layer depends on the position of the read element in the recording head. With this positioning, the inner surface of the second shield layer faces the read element and is proximate to the read element. The first shield thus has multiple surface levels. The level of the inner surface of the second shield layer is raised as compared to the level of the inner surface of the first shield layer in relation to the read element.

Similarly, the second shield comprises a third shield layer and a fourth shield layer. The fourth shield layer has an outer surface and an inner surface relative to the read element. The third shield layer has an outer surface and an inner surface relative to the read element. The outer surface of the third shield layer contacts the inner surface of the fourth shield layer to form the second shield, which is continuous. The size of the third shield layer is smaller than the size of the fourth shield layer, so the third shield layer covers a portion of the inner surface of the fourth shield layer. The positioning of third shield layer depends on the positioning of the read element in the recording head. With this positioning, the inner surface of the third shield layer faces the read element and is proximate to the read element. The second shield thus has multiple surface levels. The level of the inner surface of the third shield layer is raised as compared to the level of the inner surface of the fourth shield layer in relation to the read element.

With the multiple surface levels of each of the shields, there is a smaller separation between the shields proximate to the read element as compared to the separation between the shields away from the read element. Because of the smaller separation between the shields proximate to the read element, the shields may effectively shield the read element from unwanted magnetic fields. At the same time, because of the larger separation between the shields away from the read element, the capacitive coupling between the two shields is advantageously reduced. Consequently, the capacitive coupling would cause less noise in the recording head.

In another embodiment, the second shield comprises a single shield layer instead of being multi-layered. Therefore, the surface of the second shield is substantially flat and does not include a raised portion proximate to the read element. As with the first embodiment, there is a smaller separation between the shields proximate to the read element as compared to the separation away from the read element. The separation away from the read element is not as large as the first embodiment because the surface of the second shield is flat and is not multi-level as in the first embodiment.

Another embodiment comprises a method of fabricating a recording head. In one step of the method, an underlayer is deposited on a substrate. A first shield layer of ferromagnetic material, such as NiFe, is then formed on the underlayer. A second shield layer of ferromagnetic material is then formed on the first shield layer. The second shield layer is smaller in size than the first shield layer, and is formed on the first shield layer proximate to the position where a read element will subsequently be deposited. The first shield layer and the second shield layer form a first continuous shield of ferromagnetic material. The first shield, which will be on one side of the read element, has a surface facing the read element that has multiple levels. By forming the second shield layer on the first shield layer proximate to the read element, the surface of the first shield is raised in relation to the read element.

The layers for the read element are then deposited (on the second shield layer or on other intermediate layers). A third shield layer of ferromagnetic material is then formed proximate to the read element (on the read element or on other intermediate layers). A fourth shield layer of ferromagnetic material, which is larger in size than the third shield layer, is then formed on the third shield layer and other layers substantially planar with the third shield layer. The third shield layer and the fourth shield layer form a second continuous shield of ferromagnetic material. The second shield, which will be on the other side of the read element, has a surface facing the read element that has multiple levels. By forming the third shield layer proximate to the read element and the fourth shield layer, the surface of the second shield is raised in relation to the read element.

The method of fabrication described above is advantageously more efficient and more accurate than prior methods. The formation of the second and third shield layers advantageously allows for a greater accuracy in the placement of the shields relative to the read element as compared to prior methods. If the shield layers are electroplated, the shields layers will have a flat sidewall defining the vertical wall surface created using a lithographic mask. This flat sidewall gives a clear edge to be detected using current metrology tools. This gives a reproducible value that allows for process optimization. As compared to the prior art using a bump or continuous film, the measurement or metrology of the bump is difficult. One could measure the placement of the bump while referencing the top, bottom, or some location in between. Furthermore, the rounded edge usually consists of insulation and therefore limits metrology accuracy when using an electron beam metrology tool due to charging on the surface. Charging creates a fuzzy looking image and therefore introduces uncertainty in the bump location and/or size measurement.

The invention may include other exemplary embodiments described below.

### DESCRIPTION OF THE DRAWINGS

The same reference number represents the same element on all drawings.

FIG. 1 is a cross-sectional view of a recording head in the prior art.

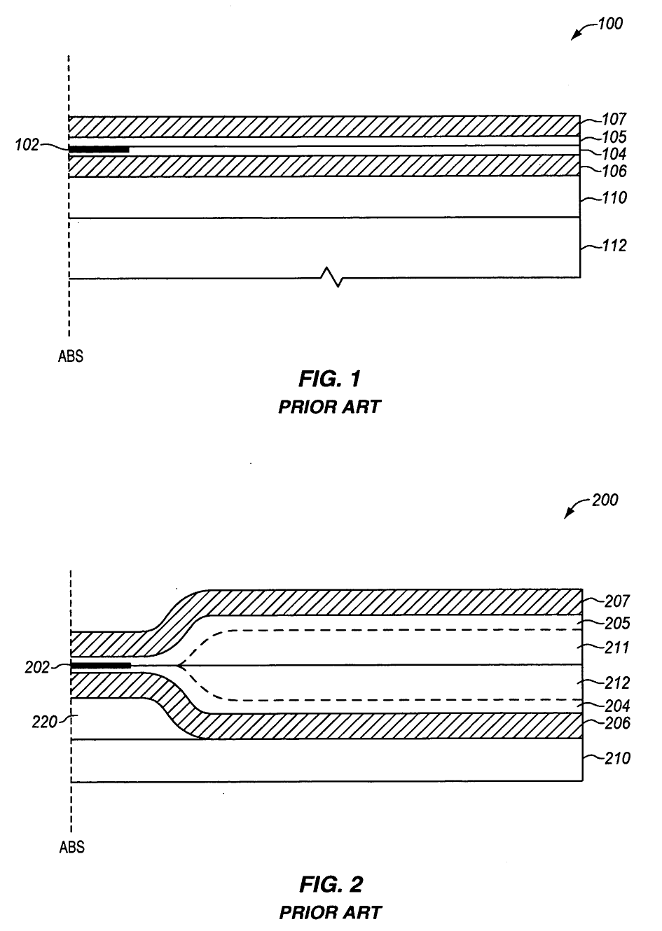

FIG. 2 is a cross-sectional view of another recording head in the prior art.

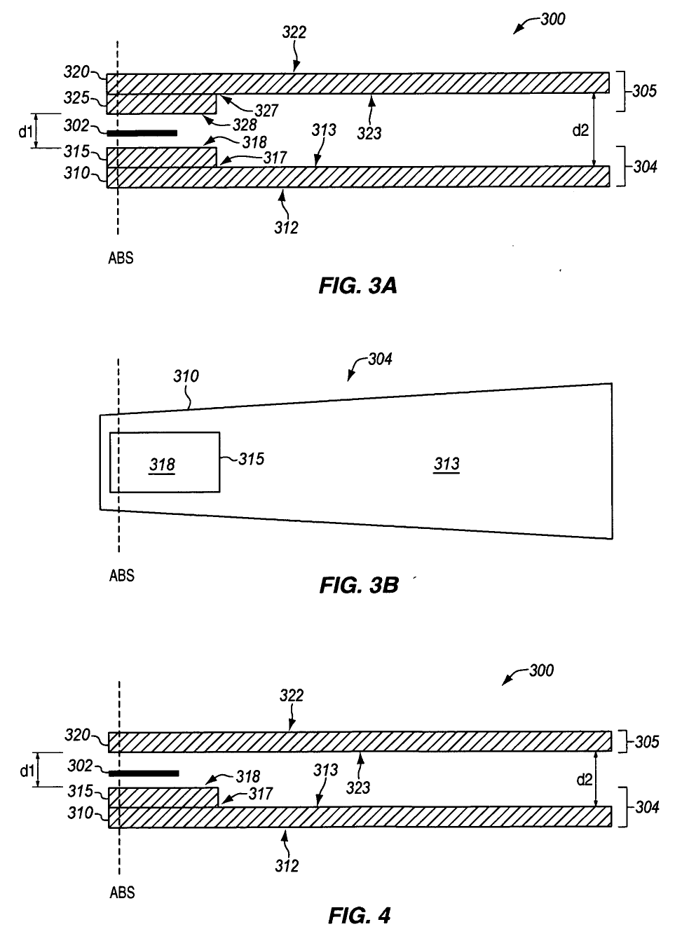

FIG. 3A is a cross-sectional view of a recording head in an exemplary embodiment of the invention.

FIG. 3B is a top view of a shield in the recording head in an exemplary embodiment of the invention.

FIG. 4 is a cross-sectional view of another embodiment of a recording head.

FIGS. 5-12 illustrate a method of fabricating a recording head in an exemplary embodiment of the invention.

FIGS. 13A, 13B, and 14-15 illustrate fabrication of a side-by-side read element and write element in an exemplary embodiment of the invention.

FIG. 16 illustrates a magnetic disk drive system in an exemplary embodiment of the invention.

### DETAILED DESCRIPTION OF THE INVENTION

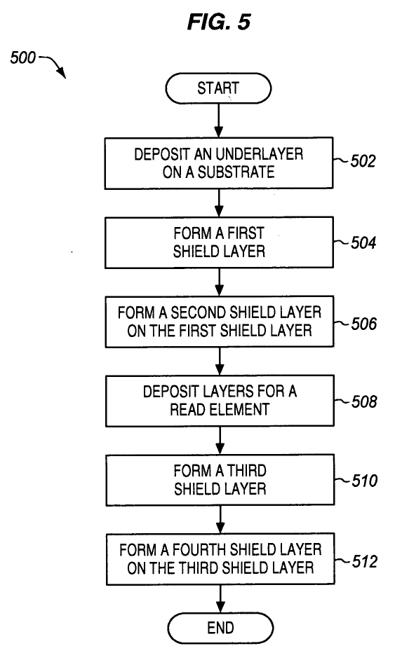

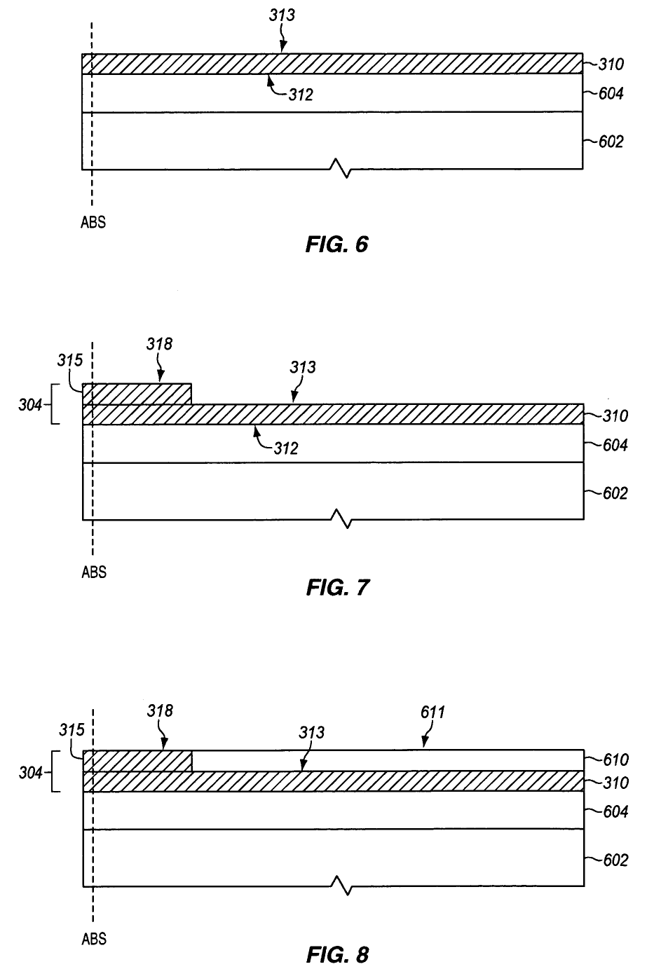

FIGS. 3A, 3B, and 4-12, 13A, 13B, and 14-16 and the following description depict specific exemplary embodiments of the invention to teach those skilled in the art how to make and use the best mode of the invention. For the purpose of teaching inventive principles, some conventional aspects of the invention have been simplified or omitted. Those skilled in the art will appreciate variations from these embodiments that fall within the scope of the invention. Those skilled in the art will appreciate that the features described below can be combined in various ways to form multiple variations of the invention. As a result, the invention is not limited to the specific embodiments described below, but only by the claims and their equivalents.

### First Embodiment of a Recording Head—FIGS. 3A-3B

FIG. 3A is a cross-sectional view of a recording head 300 in an exemplary embodiment of the invention. In this embodiment, recording head 300 includes a read element 302 between a pair of shields 304-305. The read element 302 may comprise a magnetoresistive (MR) element. The configuration of recording head 300 is just an example, and the configuration may change as desired. For instance, read element 302 may directly contact shields 304-305 if read element is a CPP read element. There may also be gap layers between the shields 304-305 and the read element 302. If the read element 302 is a CPP read element, then there may be conductive material connecting the shields 304-305 with the read element 302 through the gap layers. If the read element 302 is a CIP read element, then the gap layers insulate the shields 304-305 from the read element 302. To cover these and other scenarios, the read element 302 is merely shown as being between the shields 304-305.

The positioning of shields, such as shields 304-305, in a recording head is known to those skilled in the art. Generally, a shield has one end proximal to the read element and the ABS of the recording head. The other end of the shield is distal to the ABS.

Shield 304 is comprised of multiple layers of ferromagnetic material, such as NiFe. Shield 304 comprises a first shield layer 310 and a second shield layer 315. Shield layers 310 and 315 may each have a thickness between about 1-3 microns. Shield layer 310 has an outer surface 312 and an inner surface 313 relative to the read element 302. Outer surface 312 of shield layer 310 may sit on an underlayer (not shown) or another type of material. Inner surface 313 of shield layer 310 faces shield 305.

Shield layer 315 has an outer surface 317 and an inner surface 318 relative to the read element 302. Outer surface 317 of shield layer 315 contacts inner surface 313 of shield layer 310 to form a continuous shield 304 of ferromagnetic material. Inner surface 318 faces read element 302. Although shield layer 315 may have about the same thickness as shield layer 310, the overall size of shield layer 315 is smaller than the size of shield layer 310. Shield layer 315 covers a portion of inner surface 313 of shield layer 310.

FIG. 3B is a top view of shield 304 in an exemplary embodiment of the invention. Because shield layer 315 is smaller than shield layer 310, shield layer 315 covers a portion of inner surface 313 of shield layer 310. The positioning of shield layer 315 on shield layer 310 depends on the position of read element 302 in the recording head 300. With this positioning, inner surface 318 of shield layer 315 faces read element 302 and is proximate to read element 302. Shield 304 thus has multiple surface levels (facing upward in FIG. 3A). The level of inner surface 318 is raised as compared to the level of inner surface 313 in relation to the read element 302.

Similarly, shield 305 is comprised of multiple layers of ferromagnetic material. Shield 305 comprises a third shield layer 325 and a fourth shield layer 320. Shield layers 320 and 325 may each have a thickness between about 1-3 microns. Shield layer 320 has an outer surface 322 and an inner surface 323 relative to the read element 302. Inner surface 323 of shield layer 320 faces shield 304. Shield layer 325 has an outer surface 327 and an inner surface 328 relative to the read element 302. Outer surface 327 of shield layer 325 contacts inner surface 323 of shield layer 320 to form a continuous shield 305 of ferromagnetic material. Inner surface 328 faces read element 302. Although shield layer 325 may have about the same thickness as shield layer 320, the overall size of shield layer 325 is smaller than the size of shield layer 320. Shield layer 325 covers a portion of inner surface 323 of shield layer 320. The positioning of shield layer 325 connecting to shield layer 320 depends on the position of read element 302 in the recording head 300. With this positioning, inner surface 328 of shield layer 325 faces read element 302 and is proximate to read element 302. Shield 305 thus has multiple surface levels (facing downward in FIG. 3A). The level of inner surface 328 is raised as compared to the level of inner surface 323 in relation to read element 302.

With the multi-level surface of shields 304-305, there is a first separation (d1) between inner surface 318 of shield layer 315 and inner surface 328 of shield layer 325, which is relatively small. At the same time, there is a second separation (d2) between inner surface 313 of shield layer 310 and inner surface 323 of shield layer 320. The second separation (d2) is larger than the first separation (d1), which provides advantages. A separation ratio of d2/d1>3 is anticipated to have a noticeable reduction in noise, but any preferred separation ratio may be used. Because of the smaller separation (d1) between the shields 304-305 proximate to the read element 302, the shields 304-305 may effectively shield the read element 302 from unwanted magnetic fields. At the same time, because of the larger separation (d2) between the shields 304-305 away from the read element 302, the capacitive coupling between the two shields 304-305 is advantageously reduced. Consequently, the capacitive coupling would cause less noise in the recording head 300.

The multi-layer structure of each shield 304-305 also provides fabrication advantages that are discussed herein.

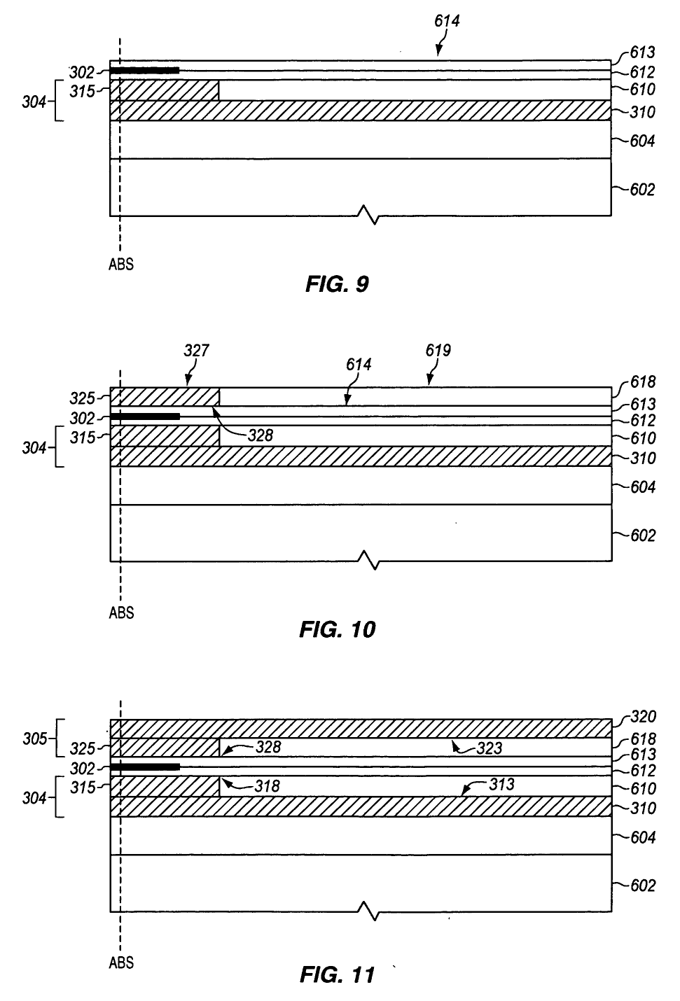

### Second Embodiment of a Recording Head—FIG. 4

FIG. 4 is a cross-sectional view of another embodiment of recording head 300. In this embodiment, shield 304 comprises two shield layers 310, 315, while shield 305 comprises a single shield layer 320. Inner surface 323 of shield layer 320 faces read element 302. Read element 302 may contact inner surface 323 of shield layer 320 in some embodiments, or there may be a layer of gap material between read element 302 and inner surface 323 of shield layer 320 in other embodiments.

Because the inner surface 323 of shield layer 320 is substantially flat, the separation (d2) between shield 304 and shield 305 is not as large as the separation (d2) in the embodiment in FIG. 3. Consequently, this embodiment does not have as large of a reduction in capacitive coupling between the shields 304-305 as the embodiment in FIG. 3. However, the reduction provided by this configuration is still an improvement over prior configurations.

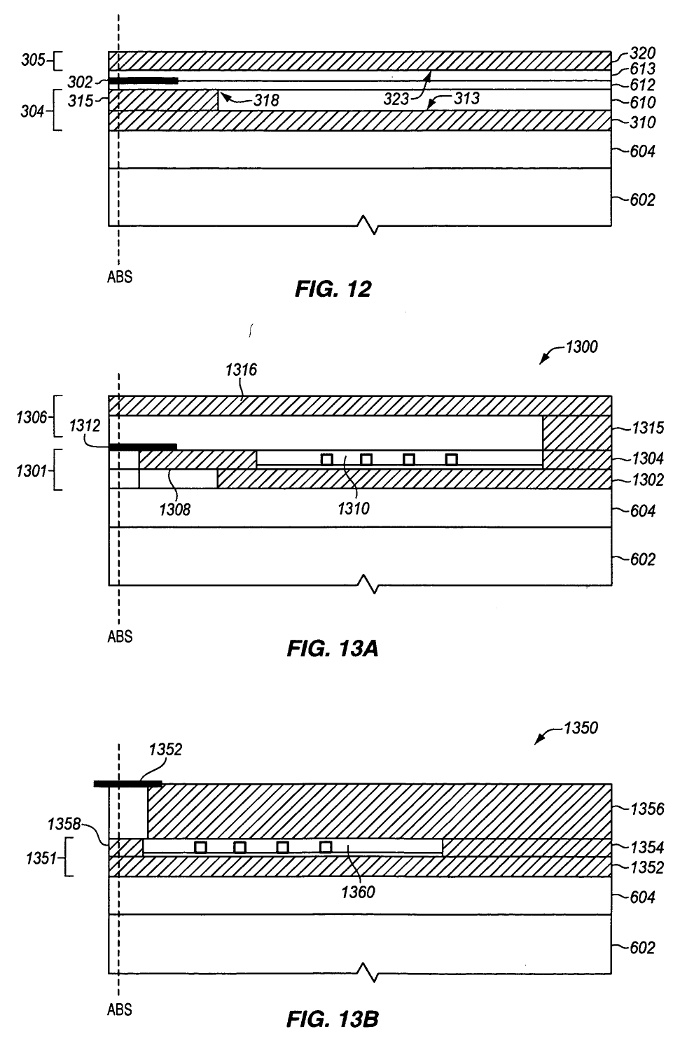

### Method of Fabrication of a Recording Head—FIGS. 5-12

FIGS. 5-12 illustrate a method of fabricating a recording head, such as recording head 300 of FIG. 3, in an exemplary embodiment of the invention. The invention is not limited to this method of fabrication, as this is just one embodiment.

In step 502 of FIG. 5, an underlayer 604 is deposited on a substrate 602 (see FIG. 6). The underlayer 604 comprises an insulating material, such as an aluminum-oxide. In step 504 of FIG. 5, a first shield layer 310 of ferromagnetic material, such as NiFe, is formed (see FIG. 4) on the underlayer 604 (see FIG. 6). Shield layer 310 may be electro-plated or formed in another manner. Shield layer 310 has an outer surface 312 and an inner surface 313.

In step 506 of FIG. 5, a second shield layer 311 is formed on a portion of inner surface 313 of shield layer 310 (see FIG. 7). Shield layer 315 has an inner surface 318, which is the top surface in this embodiment. Shield layer 315 is smaller in size than shield layer 310, and is formed on shield layer 310 proximate to the position where a read element will subsequently be deposited. In this embodiment, shield layer 315 is also formed proximate to the future ABS, which is illustrated by a dotted line. Shield layer 315 may be formed with an addition process, such as electro-plating. Alternatively, shield layer 315 may be formed with a subtractive process, such as a sputtering/etching process. Shield layer 310 and shield layer 315 form a continuous shield 304 of ferromagnetic material.

In FIG. 8, a layer of insulation material 610 is deposited on inner surface 313 of shield layer 310 wherever shield layer 315 does not cover inner surface 313. At this point, the top inner surface 318 of the shield layer 315 and the top surface 611 of the insulation layer 610 may be polished or otherwise processed to form a planar surface.

In step 508 of FIG. 5, layers for a read element 302 are deposited (see FIG. 9). Read element 302 is shown as being deposited on a gap layer 612. Gap layer 612 is deposited between shield layer 315 and read element 302. Read element 302 may be deposited on any desired surface, depending on whether read element is a CIP or CPP, etc. For instance, if read element 302 comprises a CPP read element, the read element 302 may be deposited on inner surface 318 of shield layer 315. Read element 302 may also be deposited on gap layer 612, where gap layer 612 includes electrically conductive material (not shown) that connects read element 302 to shield layer 315. FIG. 9 also shows a gap layer 613 deposited on top of read element 302 and having a top surface 614.

The layers of the read element 302 are deposited so that one end of the read element 302 is adjacent to the ABS in this embodiment. In other embodiment, read element 302 may be deposited away from the ABS with a flux guide connecting the read element 302 to the ABS.

In step 510 of FIG. 5, a third shield layer 325 is formed on a portion of surface 614 of gap layer 613 (see FIG. 10). Shield layer 325 has an outer surface 327, which is the top surface in FIG. 10, and an inner surface 328. Shield layer 325 is formed proximate to read element 302 and proximate to the future ABS. If read element 302 comprises a CPP read element, then gap layer 613 may include electrically conductive material (not shown) that connects read element 302 to shield layer 325. Shield layer 325 may be formed with an addition process, such as electroplating. Alternatively, shield layer 325 may be formed with a subtractive process, such as a sputtering/etching process. In FIG. 10, an insulation layer 618 is deposited on surface 614 of gap layer 613 wherever shield layer 325 does not cover surface 614. Insulation layer 618 has a top surface 619.

In step 512 of FIG. 5, a fourth shield layer 320 of ferromagnetic material is formed on the outer surface 327 of shield layer 320 and surface 619 of insulation layer 618 (see FIG. 11). Shield layer 320 may be electro-plated or formed in another manner. Shield layer 320 has an inner surface 323 facing and corresponding with inner surface 313 of shield layer 310. Shield layer 320 and shield layer 325 form a continuous shield 305 of ferromagnetic material.

Other layers may be deposited on shield layer 320, such as layers for a write element (not shown). Once all of the layers are deposited, the recording head may be lapped to form the ABS surface. Also, the method 500 described for fabricating the read element may further include steps to simultaneously fabricate a write element. To simultaneously fabricate the write element and the read element, the two elements would be side-by-side in the recording head. Side-by-side fabrication is described later herein.

With the multi-level surface of shields 304-305, the separation between inner surface 318 of shield layer 315 and inner surface 328 of shield layer 325 is relatively small (see FIG. 11). At the same time, the separation between inner surface 313 of shield layer 310 and inner surface 323 of shield layer 320 is larger. Because of the smaller separation between the shields 304-305 proximate to the read element 302, the shields 304-305 may effectively shield the read element 302 from unwanted magnetic fields. At the same time, because of the larger separation between the shields 304-305 away from the read element 302, the capacitive coupling between the two shields 304-305 is advantageously reduced.

Shield 305, as shown in FIG. 11, does not have to be multi-layer in other embodiments. Therefore, in an alternative embodiment, steps 510 and 512 of method 500 may be replaced with a single step of forming a shield layer 320 on surface 614 of gap layer 613 (see FIG. 12). Shield layer 320 has an inner surface 323 that faces read element 302. Because the inner surface 323 is substantially flat, the separation between shield 304 and shield 305 is not as large as the separation in the embodiment in FIG. 11.

The method of fabrication described above is advantageously more efficient and more accurate than prior methods.

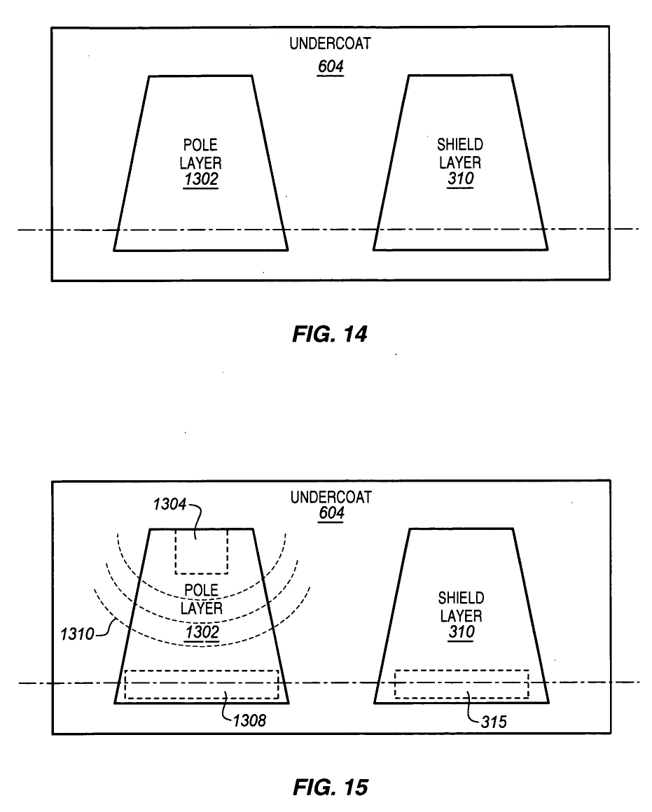

The fabrication method 500 as illustrated in FIGS. 5-12 may lend well to fabrication of a side-by-side read element and write element in a recording head. FIG. 13A illustrates the layers of a write element 1300 in an exemplary embodiment of the invention. Write element 1300 includes a first pole 1301, a back-gap 1304, and a second pole 1306. The first pole 1301 is comprised of a first layer 1302 and a second layer 1308. The first layer 1302 sits on an underlayer 604 which sits on a substrate 602. A pole tip 1312 is connected to the second layer 1308 of the first pole 1301. The second pole 1306 is comprised of a third layer 1315 and a fourth layer 1316. A coil 1310 for the write element 1300 is sandwiched between the poles 1301 and 1306. Write element 1300 may include other layers not shown. Write element 1300 may also take on other configurations in other embodiments.

FIG. 13B illustrates the layers of a write element 1350 in another exemplary embodiment of the invention. Write element 1350 includes a first pole 1351, a back-gap 1354, and a second pole 1356. The first pole 1351 is comprised of a first layer 1352 and a second layer 1358. The first layer 1352 sits on an underlayer 604 which sits on a substrate 602. A coil 1360 for the write element 1350 is sandwiched between the poles 1351 and 1356. A pole tip 1352 is connected to the second pole 1356. Write element 1350 may include other layers not shown.

Assume for the following description that the read element 302 in FIG. 11 is side-by-side with write element 1300 (see FIG. 13A), which would be out of the page in FIG. 13A. Read element 302 and write element 1300 are formed on the same underlayer 604. In the fabrication process, shield layer 310 of shield 304 and the first layer 1302 of the first pole 1301 are formed with the same process on underlayer 604. FIG. 14 illustrates shield layer 310 and the first layer 1302 deposited on the underlayer 604. Next, the back-gap 1304, the second layer 1308 of the first pole 1301, the coil 1310, and shield layer 315 of shield 304 may be formed with the same process (see FIG. 15). Corresponding insulation layers may also be deposited. These layers may then be polished to provide a planar surface. The pole tip 1312 and the read element 302 may then be deposited (see FIGS. 11 and 13A). Advantageously, the pole tip 1312 and the read element 302 are formed on the same planar surface. The pole tip 1312 and the read element 302 are essentially self-aligned by being on the same planar surface, which provides for a more effective recording head.

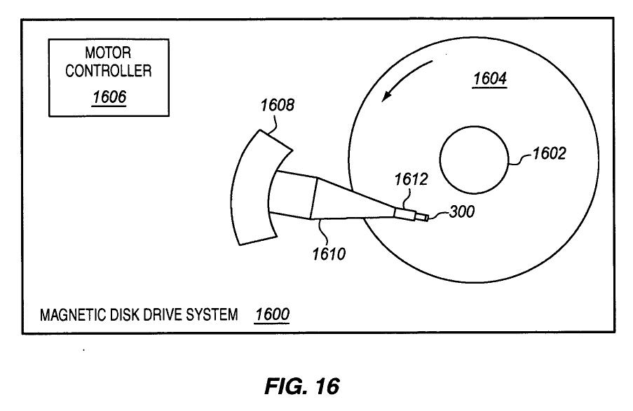

FIG. 16 illustrates a magnetic disk drive system 1600 in an exemplary embodiment of the invention. Magnetic disk drive system 1600 includes a spindle 1602, a magnetic disk 1604, a motor controller 1606, an actuator 1608, an actuator arm 1610, a suspension arm 1612, and a recording head 300 utilizing the shielding described herein. Spindle 1602 supports and rotates a magnetic disk 1604 in the direction indicated by the arrow. A spindle motor (not shown) rotates spindle 1602 according to control signals from motor controller 1606. Recording head 300 is supported by suspension arm 1612 and actuator arm 1610. Actuator arm 1610 is connected to actuator 1608 that is configured to rotate in order to position recording head 300 over a desired track of magnetic disk 1604. Magnetic disk drive system 1600 may include other devices, components, or systems not shown in FIG. 16. For instance, a plurality of magnetic disks, actuators, actuator arms, suspension arms, and recording heads may be used.

When magnetic disk 1604 rotates, air generated by the rotation of magnetic disk 1604 causes an air bearing surface (ABS) of recording head 300 to ride on a cushion of air a particular height above magnetic disk 1604. The height depends on the shape of the ABS. As recording head 300 rides on the cushion of air, actuator 1608 moves actuator arm 1610 to position a read element (not shown) and a write element (not shown) in recording head 300 over selected tracks of magnetic disk 1604. The read element and write element may be positioned side-by-side as illustrated in FIGS. 14-15.

I claim:

1. A recording head of a magnetic disk drive system, the recording head comprising:
a read element;
a first shield layer of ferromagnetic material having an inner surface and an outer surface relative to the read element;
a second shield layer of ferromagnetic material having a smaller size than the first shield layer, wherein an outer surface of the second shield layer contacts the inner surface of the first shield layer to form a continuous first shield of ferromagnetic material on one side of the read element, wherein an inner surface of the second shield layer is proximate to the read element;
a third shield layer of ferromagnetic material having an inner surface and an outer surface relative to the read element; and
a fourth shield layer of ferromagnetic material having a larger size than the third shield layer, wherein the outer surface of the third shield layer contacts an inner surface of the fourth shield layer to form a continuous second shield of ferromagnetic material on the opposite side of the read element, wherein the inner surface of the third shield layer is proximate to the read element.

2. The recording head of claim 1 wherein a separation between the inner surface of the second shield layer and the inner surface of the third shield layer is less than a separation between the inner surface of the first shield layer and the inner surface of the fourth shield layer.

3. The recording head of claim 1 wherein the read element comprises a magnetoresistive (MR) element.

4. The recording head of claim 3 wherein the read element comprises one of a current perpendicular to the planes (CPP) read element or a current in plane (CIP) read element.

5. A recording head of a magnetic disk drive system, the recording head comprising:
a read element;
a first shield layer of ferromagnetic material having an inner surface and an outer surface relative to the read element;
a second shield layer of ferromagnetic material having a smaller size than the first shield layer, wherein an outer surface of the second shield layer contacts the inner surface of the first shield layer to form a continuous first shield of ferromagnetic material on one side of the read element, wherein an inner surface of the second shield layer is proximate to the read element; and
a third shield layer of ferromagnetic material forming a second shield of ferromagnetic material on the opposite side of the read element, wherein an inner surface of the third shield layer is proximate to the read element.

6. The recording head of claim 5 wherein a separation between the inner surface of the second shield layer and the inner surface of the third shield layer is less than a separation between the inner surface of the first shield layer and the inner surface of the third shield layer.

7. The recording head of claim 5 wherein the read element comprises a magnetoresistive (MR) element.

8. The recording head of claim 7 wherein the read element comprises one of a current perpendicular to the planes (CPP) read element or a current in plane (CIP) read element.

9. A magnetic disk drive system, comprising:
a magnetic disk; and
a recording head that includes a read element for reading data from the magnetic disk, the recording head comprising:
the read element;
a first shield layer of ferromagnetic material having an inner surface and an outer surface relative to the read element;
a second shield layer of ferromagnetic material having a smaller size than the first shield layer, wherein an outer surface of the second shield layer contacts the inner surface of the first shield layer to form a continuous first shield of ferromagnetic material on one side of the read element, wherein an inner surface of the second shield layer is proximate to the read element;
a third shield layer of ferromagnetic material having an inner surface and an outer surface relative to the read element; and
a fourth shield layer of ferromagnetic material having a larger size than the third shield layer, wherein the outer surface of the third shield layer contacts an inner surface of the fourth shield layer to form a continuous second shield of ferromagnetic material on the opposite side of the read element, wherein the inner surface of the third shield layer is proximate to the read element.

10. The magnetic disk drive system of claim 9 wherein a separation between the inner surface of the second shield layer and the inner surface of the third shield layer is less than a separation between the inner surface of the first shield layer and the inner surface of the fourth shield layer.

11. The magnetic disk drive system of claim 9 wherein the read element comprises a magnetoresistive (MR) element.

12. The magnetic disk drive system of claim 11 wherein the read element comprises one of a current perpendicular to the planes (CPP) read element or a current in plane (CIP) read element.

13. The magnetic disk drive system of claim 9 wherein the recording head further comprises:
a write element side-by-side with the read element.

14. A method of fabricating a magnetic recording head, the method comprising:
forming a first shield layer of ferromagnetic material;
forming a second shield layer of ferromagnetic material, having a smaller size than the first shield layer, on an inner surface of the first shield layer to form a continuous first shield of ferromagnetic material;
forming the layers of a read element above an inner surface of the second shield layer so that the inner surface of the second shield layer is proximate to the read element;
forming a third shield layer of ferromagnetic material above the read element so that an inner surface of the third shield layer is proximate to the read element; and
forming a fourth shield layer of ferromagnetic material, having a size larger than the third shield layer, on an outer surface of the third shield layer to form a continuous second shield of ferromagnetic material.

15. The method of claim 14 wherein forming a first shield layer comprises electro-plating the first shield layer on an underlayer.

16. The method of claim 15 wherein forming the second shield layer comprises electro-plating the second shield layer on the first shield layer.

17. The method of claim 16 wherein the second shield layer is electro-plated on an end of the first shield layer proximate to the read element and proximate to the air bearing surface (ABS) of the recording head.

18. The method of claim 16 wherein forming the third shield layer comprises electro-plating the third shield layer.

19. The method of claim 18 wherein the third shield layer is electro-plated proximate to the read element and proximate to the air bearing surface (ABS) of the recording head.

20. The method of claim 18 wherein forming the fourth shield layer comprises electro-plating the fourth shield layer on the third shield layer.

21. The method of claim 14 further comprising:
forming a first gap layer between the second shield layer and the read element.

22. The method of claim 21 wherein first gap layer includes electrically conductive material connecting the second shield layer to the read element.

23. The method of claim 21 further comprising:
forming a second gap layer between the read element and the third shield layer.

24. The method of claim 23 wherein second gap layer includes electrically conductive material connecting the third shield layer to the read element.

25. The method of claim 14 further comprising:
forming layers for a write element simultaneously with the layers of the read element.

26. The method of claim 14 wherein a separation between the inner surface of the second shield layer and the inner surface of the third shield layer is less than a separation between the inner surface of the first shield layer and an inner surface of the fourth shield layer.

27. A method of fabricating a magnetic recording head, the method comprising:
forming a first shield layer of ferromagnetic material;
forming a second shield layer of ferromagnetic material, having a smaller size than the first shield layer, on an inner surface of the first shield layer to form a continuous first shield of ferromagnetic material;
forming the layers of a read element above an inner surface of the second shield layer so that the inner surface of the second shield layer is proximate to the read element; and
forming a third shield layer of ferromagnetic material above the read element to form a second shield of ferromagnetic material.
